(19) United States
(12) Patent Application Publication
(10) Pub. No.: US 2025/0204496 A1
(43) Pub. Date: Jun. 26, 2025

(54) Pet Restraint System

(71) Applicant: Ashley Nicole Newman, Goose creek, SC (US)

(72) Inventor: Ashley Nicole Newman, Goose creek, SC (US)

(21) Appl. No.: 18/990,946

(22) Filed: Dec. 20, 2024

Related U.S. Application Data
(60) Provisional application No. 63/612,798, filed on Dec. 20, 2023.

(51) Int. Cl. A01K 27/00; B60R 22/10

(52) U.S. Cl. CPC A01K 27/005; A01K 27/003; B60R 22/10

(57) ABSTRACT

A pet restraint system includes a collar clip, a pet lead, and a headrest anchor. The collar clip includes a first lever, a second lever, and a clip body. The clip body includes an upper body portion with a collar-receiving cavity that is centrally positioned on the clip body. The first clasp of the first lever and the second clasp of the second lever operatively occlude a cavity opening of the collar-receiving cavity. The pet lead includes a lead cable, a first lead loop, and a second lead loop. The headrest anchor includes an anchor cable, a first anchor loop, and a second anchor loop. The collar clip is coupled to the first lead loop by a cable connector. The headrest anchor is coupled to the pet lead by way of a swivel connector between the second lead loop and the anchor cable.

The current application claims a priority to the U.S. provisional patent application Ser. No. 63/612,798 filed on Dec. 20, 2023.

### FIELD OF THE INVENTION

The present invention generally relates to a vehicle restraint system capable of securing a pet to the seat of an existing road vehicle. More specifically, the present invention protects the pet from severe injury in case of a vehicle collision or emergency breaking.

### BACKGROUND OF THE INVENTION

Pets are commonly transported in vehicles and exposed to the hazards of abrupt movements or even accidents. Some routine hazards result from breaking, accelerating, turning, and other typical automotive movements. These hazards can result in serious injury to pets placed on car seats, dashboards, foot wells, or other areas in a vehicle. Additionally, an unsecured pet may also lead to a distracted driver, which leads to even more safety concerns that affect all passengers as well as other vehicles on the road.

Although most vehicles inherently provide safety features such as seat belts and airbags, such restraints may not adequately protect a human passenger from an unsecured pet within a vehicle, during abrupt movements. As a result, all passengers are subject to risk despite an automobile's inherent safety features.

A number of pet restraints have been developed. However, general statistics show that pet owners have not sufficiently adopted these measures. According to the American Automobile Association, “unrestrained pets cause more than 30,000 accidents annually,” despite the availability of pet restraints.

Therefore, a need exists for a vehicle restraint system capable of securing a pet to the seat of an existing road vehicle that prevents the pet from severe injury in case of a vehicle collision or emergency breaking.

### BRIEF DESCRIPTION OF THE DRAWINGS

To easily identify the discussion of any particular element or act, the most significant digit or digits in a reference number refer to the figure number in which that element is first introduced.

FIG. 1 illustrates a pet restraint system 100 in a first view in accordance with one embodiment.

FIG. 2 illustrates a pet restraint system 200 in a closed configuration in accordance with one embodiment.

FIG. 3 illustrates a pet restraint system 300 in an open configuration in accordance with one embodiment.

FIG. 4 illustrates a collar clip 400 in a sectional view in a closed configuration in accordance with one embodiment.

FIG. 5 illustrates a collar clip 500 in a sectional view in an open configuration in accordance with one embodiment.

FIG. 6 illustrates a pet restraint system 600 in accordance with one embodiment.

### DETAILED DESCRIPTION OF THE INVENTION

All illustrations of the drawings are for the purpose of describing selected versions of the present invention and are not intended to limit the scope of the present invention.

In an embodiment, a pet restraint system comprises a collar clip, a pet lead, and a headrest anchor. The collar clip comprises a first lever, a second lever, and a clip body, wherein the first lever and the second lever are rotatably coupled to the clip body by way of a fulcrum. The first lever comprises a first clasp, and the second lever comprises a second clasp. The clip body comprises an upper body portion and a lower body portion, wherein the upper body portion comprises a collar-receiving cavity that is centrally positioned on the clip body. The first clasp and the second clasp operatively occlude a cavity opening of the collar-receiving cavity. The lower body comprises a cable connector. The pet lead comprises a lead cable, a first lead loop, and a second lead loop. The first lead loop and the second lead loop are each formed by an end of the lead cable being looped and secured by a lead loop sleeve. The headrest anchor comprises an anchor cable, a first anchor loop, and a second anchor loop. The first anchor loop and the second anchor loop are each formed by an end of the anchor cable being looped and secured by an anchor loop sleeve. The headrest anchor is rotatably coupled to the pet lead by way of a swivel connector between the second lead loop and the anchor cable.

The first lead loop and the second lead loop may each comprise a loop shield, wherein the loop shield protects the lead cable from damage and may be constructed from metal. The loop shield of the first lead loop is generally configured to protect the first lead loop from damage and is more specifically configured to reduce friction between engagement surfaces of the cable connector and the first lead loop. Likewise, the loop shield of the second lead loop is generally configured to protect the second lead loop from damage and is more specifically configured to reduce friction between engagement surfaces of the swivel connector and the second lead loop.

The collar clip may further comprise at least one tensioner that is coupled to the first lever and the second lever. Other technical features may be readily apparent to one skilled in the art from the following figures, descriptions, and claims.

The collar clip may also be rotatably coupled to the first lead loop by way of the cable connector. Other technical features may be readily apparent to one skilled in the art from the following figures, descriptions, and claims.

The anchor cable may also be configured to attach to a vehicle seat by threading one headrest post through the first anchor loop and by threading another headrest post through the second anchor loop. Other technical features may be readily apparent to one skilled in the art from the following figures, descriptions, and claims.

The pet restraint system provides a more effective way to anchor a pet into a car than the current seat belt or around the headrest models on the market. The anchor cable and the lead cable may be constructed from steel and sleeved with a fabric material improving durability as well as preventing the steel cable from damaging the pet or the car seat.

The pet restraint system may be constructed from a plurality of chew proof materials. The pet restraint system may be anchored to a vehicle seat by connecting the anchor cable directly to the posts of the headrest in a vehicle.

The pet restraint system may be constructed from two sections of 7-strand steel cable that connect in a “T” at a steel swivel forming the lead cable and the anchor cable. The anchor cable is a top portion of the “T” and connects to the headrest, while the lead cable is coupled to the collar clip that attaches to the collar of a dog. In some configurations, the anchor cable may utilize carabiners as a way to quickly attach to the posts of a vehicle's headrest.

The anchor cable and the lead cable may be arranged in a T-shaped configuration. This configuration allows at least two anchor points to the headrest instead of just wrapping anchor cable around the headrest. The swivel connector is at a nexus of the T-shaped configuration and is provided to prevent entanglement by the pet with the length of the anchor cable and/or the lead cable. The collar clip allows for a quick attachment to a dog's collar ensuring the dog is secured.

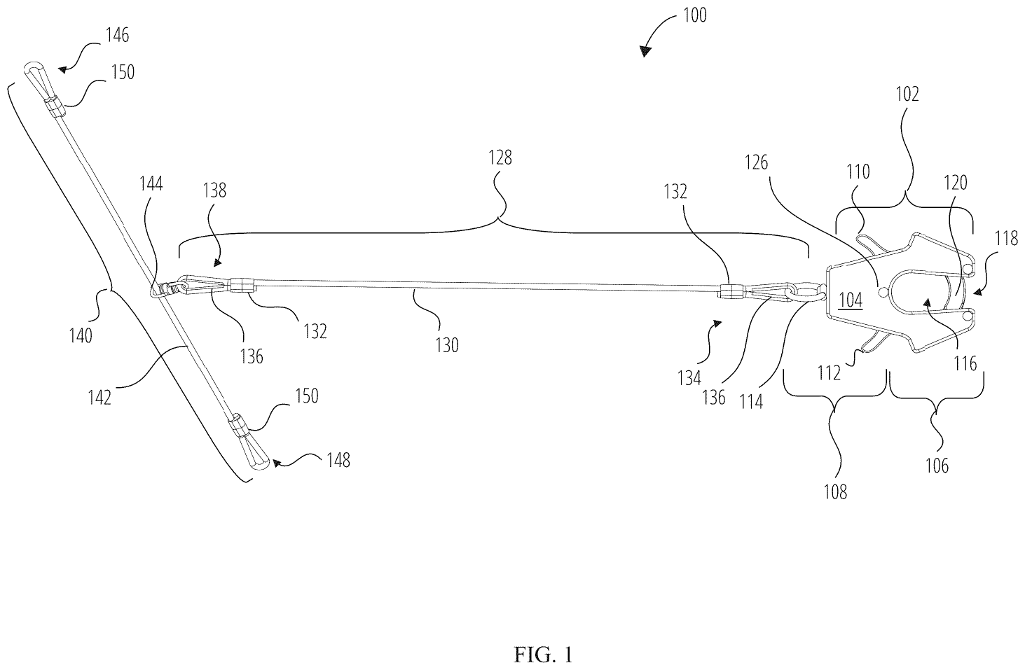

Referencing FIG. 1, a pet restraint system 100 is provided in accordance with one embodiment. The pet restraint system 100 comprises a collar clip 102, a pet lead 128, and a headrest anchor 140. The collar clip 102 comprises a clip body 104, a first lever 110, and a second lever 112. The clip body 104 comprises an upper body portion 106 and a lower body portion 108. The upper body portion 106 comprises a collar-receiving cavity 116, and the collar-receiving cavity 116 has a cavity opening 118. The lower body portion 108 comprises a fulcrum 126 and a cable connector 114. In the pet restraint system 100, the cavity opening 118 is occluded by a clasp 120 of the first lever 110 and a clasp 120 of the second lever 112. The cable connector 114 is rotatably coupled to the clip body 104.

The pet lead 128 is coupled to the collar clip 102 by way of the cable connector 114. The pet lead 128 comprises a lead cable 130, a first lead loop 134, and a second lead loop 138. The first lead loop 134 and the second lead loop 138 are formed by looping the ends of the lead cable 130 and closing each of the ends with a loop sleeve 132. The first lead loop 134 and the second lead loop 138 each comprise a loop shield 136 that surrounds the interior of both the first loop 134 and the second loop 138 that protects and reduces friction between the coupling of the lead cable 128 to the headrest anchor 140 and the collar clip 102. The first lead loop 134 couples to the collar clip 102 by way of the cable connector 114. The second lead loop 138 is coupled to the headrest anchor 140 by way of a swivel connector 144.

The headrest anchor 140 comprises an anchor cable 142, a first anchor loop 146, and a second anchor loop 148. The first anchor loop 146 and the second anchor loop 148 are formed by looping the ends of the anchor cable 142 and securing each end with an anchor loop sleeve 150. The anchor cable 142 is threaded through a swivel connector 144 and is rotatably coupled to the pet lead 128.

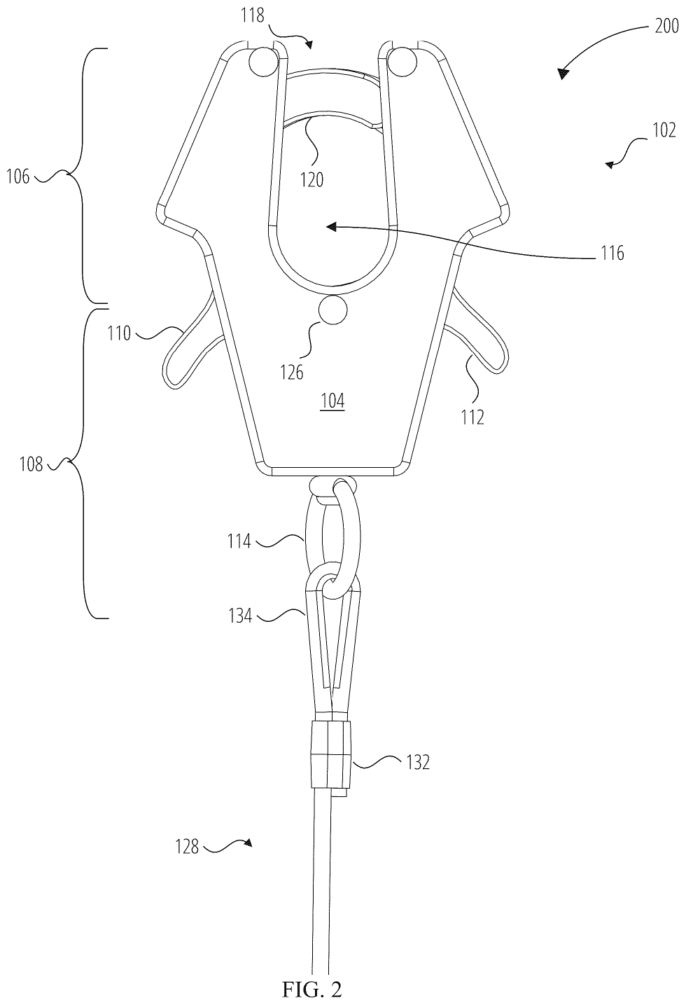

Referencing FIG. 2, a pet restraint system 200 is provided in an enhanced view of the collar clip 102 in a closed configuration in accordance with one embodiment. The pet restraint system 200 comprises a collar clip 102 and a pet lead 128. The collar clip 102 comprises a clip body 104, a first lever 110, and a second lever 112.

The clip body 104 comprises a lower body portion 108, and an upper body portion 106. The upper body portion 106 is configured to be wider than the lower body portion 108. The width of the upper body portion 106 compared to the lower body portion 108 may be configured to shield the first lever 110 and the second lever 112 while the collar clip 102 is coupled to a pet's collar. This width may also prevent the engagement of the first lever 110 and the second lever 112 that may result in their compression that may move the clasp 120 out of the cavity opening 118.

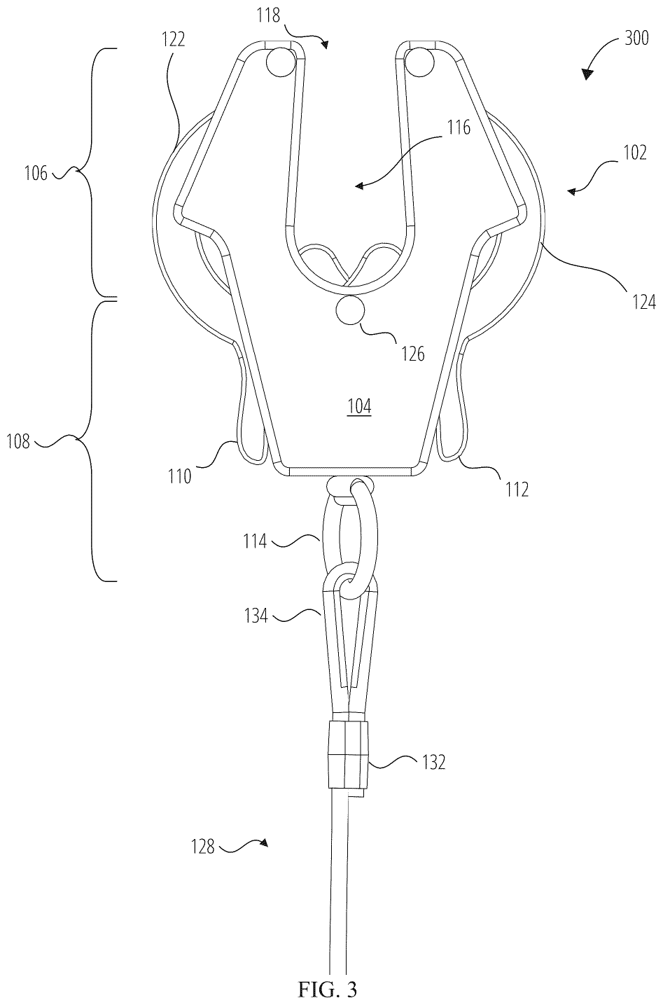

Referencing FIG. 3, a pet restraint system 300 is provided in an enhanced view of the collar clip 102 in an open configuration, in accordance with one embodiment. In the pet restraint system 300, the first lever 110 and the second lever 112 are engaged moving a first clasp 122 of the first lever 110 and a second clasp 124 of the second lever 112 out of the cavity opening 118 allowing the collar clip 102 to couple with a pet's collar. In some configurations, the first lever 110 and the second lever 112 may be compressed by pressing the first lever 110 and the second lever 112 towards the center of the clip body 104. The resulting compression may cause the first lever 110 and the second lever 112 to rotate about the fulcrum 126.

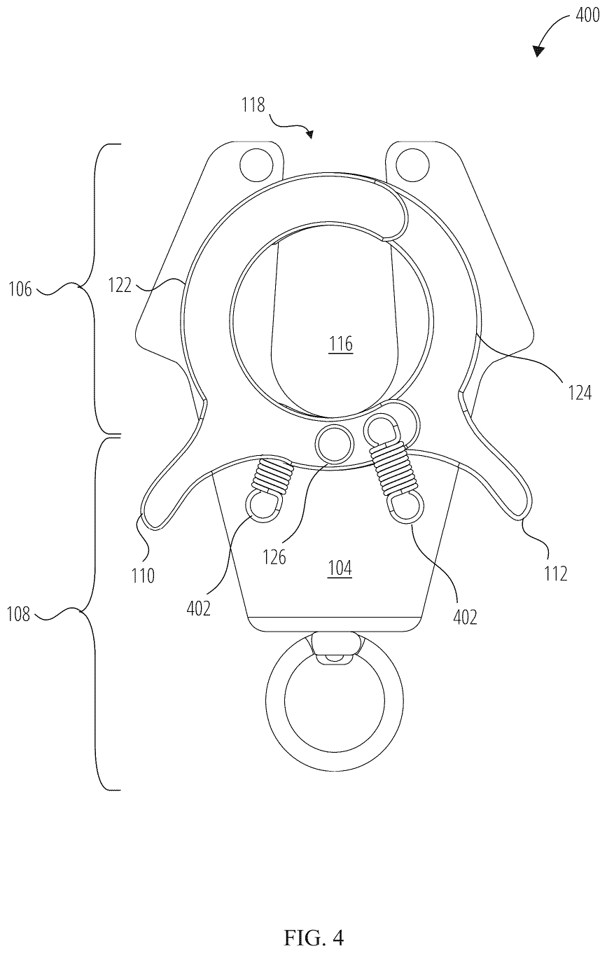

FIG. 4 illustrates a sectional view of a collar clip 400 in a closed configuration in accordance with one embodiment. The collar clip 400 comprises a tensioner 402 coupled to both the first lever 110 and the second lever 112. In the closed state, the tensioner 402 are at rest and the first clasp 122 and the second clasp 124 are positioned occluding the cavity opening 118 from the collar-receiving cavity 116. Although a tensioner 402 is shown as set of springs, each coupled to the first lever 110 and the second lever 112, the tensioner 402 may be accomplished by a single spring as well as a plurality of springs. In some configurations, the tensioner 402 may be accomplished by tensioning bar.

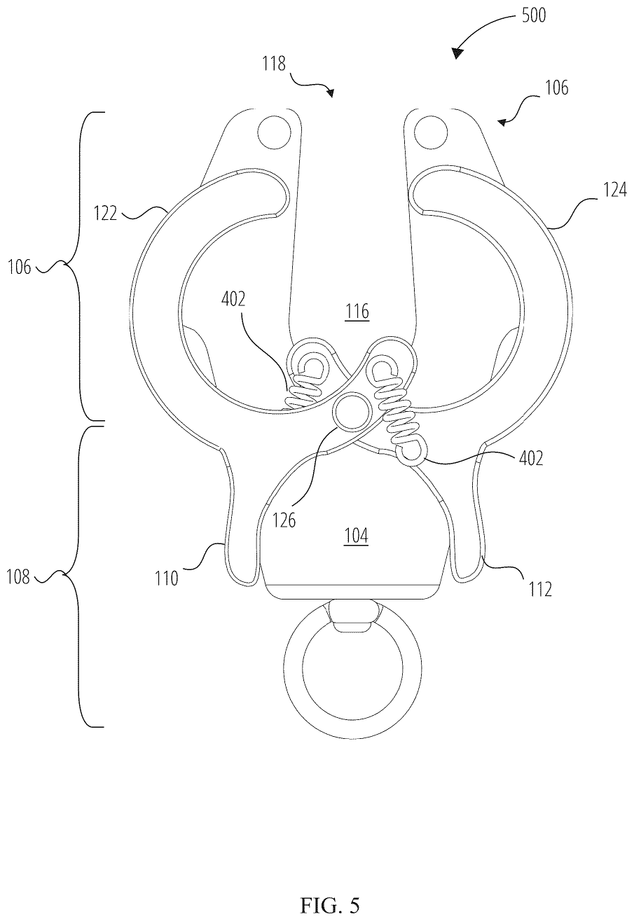

FIG. 5 illustrates a sectional view of a collar clip 500 in an open configuration in accordance with one embodiment. The collar clip 500 illustrates the compression of the first lever 110 and the second lever 112 towards the center of the clip body 104. The first clasp 122 and the second clasp 124 move out of the cavity opening 118 allowing access to the collar-receiving cavity 116. The compression engages the at least one tensioner 402 and upon release returns the first clasp 122 and the second clasp 124 to a resting state, wherein the cavity opening 118 of the cavity 116 is occluded.

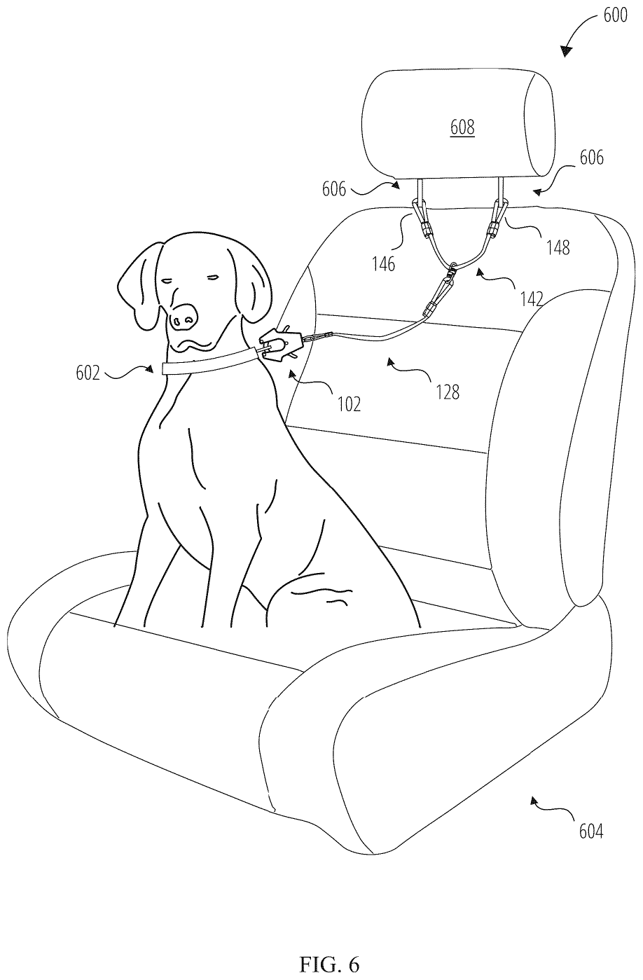

Referencing FIG. 6, a pet restraint system 600 is in an operative configuration in accordance with one embodiment. The pet restraint system 600 comprises a collar clip 102, a pet lead 128, and an anchor cable 142. The pet restraint system 600 is coupled to a vehicle seat 604 and a collar 602 attached to a pet, in embodiment the pet is a dog. The collar clip 102 is detachably coupled to the collar 602 by way of a ring on the collar 602. The collar clip 102 is secured to the vehicle seat 604 by way of the anchor cable 142. The first anchor loop 146 and the second anchor loop 148 and threaded by the posts 606 of the headrest 608.

In an embodiment, a user may remove the headrest 608 from the vehicle seat 604 exposing the posts 606. The user may then thread a post 606 through each of the first anchor loop 146 and the second anchor loop 148 before reattaching the headrest 608 to the vehicle seat 604.

Although the invention has been explained in relation to its preferred embodiment, it is to be understood that many other possible modifications and variations can be made without departing from the spirit and scope of the invention.

What is claimed is:

1. A pet restraint system comprising:
a collar clip;
a pet lead;
a headrest anchor;
a fulcrum;
a swivel connector;
the collar clip comprising a first lever, a second lever, and a clip body;
the pet lead comprising a lead cable, a first lead loop, and a second lead loop;
the headrest anchor comprising an anchor cable, a first anchor loop, and a second anchor loop;
the first lever comprising a first clasp;
the second lever comprising a second clasp;
the clip body comprising an upper body portion and a lower body portion;
the upper body portion comprising a collar-receiving cavity;
the lower body comprising a cable connector;
the first lever and the second lever being rotatably coupled to the clip body by the fulcrum;
the collar-receiving cavity being centrally positioned on the clip body;
a cavity opening of the collar-receiving cavity being operatively occluded by the first clasp and the second clasp;
the first lead loop and the second lead loop being each formed by an end of the lead cable being looped and secured by a lead loop sleeve;
the first anchor loop and the second anchor loop being each formed by an end of the anchor cable being looped and secured by an anchor loop sleeve;
the collar clip being rotatably coupled to the first lead loop by the cable connector; and
the second lead loop being rotatably coupled to the anchor cable by the swivel connector.

2. The pet restraint system as claimed in claim 1 comprising:
the first lead loop and the second lead loop each comprise a loop shield;
the loop shield of the first lead loop being configured to protect the first lead loop from damage; and
the loop shield of the second lead loop being configured to protect the second lead loop from damage.

3. The pet restraint system as claimed in claim 2, wherein the loop shield of the first lead loop is made of metal.

4. The pet restraint system as claimed in claim 2, wherein the loop shield of the second lead loop is made of metal.

5. The pet restraint system as claimed in claim 2, wherein the loop shield of the first lead loop is configured to reduce friction between engagement surfaces of the cable connector and the first lead loop.

6. The pet restraint system as claimed in claim 2, wherein the loop shield of the second lead loop is configured to reduce friction between engagement surfaces of the swivel connector and the second lead loop.

7. The pet restraint system as claimed in claim 1 comprising:
the collar clip further comprising at least one tensioner; and
the at least one tensioner being coupled to the first lever and the second lever.

8. The pet restraint system as claimed in claim 1, wherein the anchor cable is configured to attach to a vehicle seat by threading one headrest post through the first anchor loop and by threading another headrest post through the second anchor loop.

9. The pet restraint system as claimed in claim 1, wherein the anchor cable is a steel cable sleeved with a fabric material.

10. The pet restraint system as claimed in claim 9, wherein the steel cable is a 7-strand steel cable.

11. The pet restraint system as claimed in claim 1, wherein the lead cable is a steel cable sleeved with a fabric material.

12. The pet restraint system as claimed in claim 11, wherein the steel cable is a 7-strand steel cable.

13. The pet restraint system as claimed in claim 1, wherein the swivel connector is a steel swivel.

14. The pet restraint system as claimed in claim 1 comprising:
the anchor cable and the lead cable being arranged into a T-shaped configuration; and
the swivel connector being at a nexus of the T-shaped configuration.

15. The pet restraint system as claimed in claim 1, wherein a width of the upper body portion is configured to shield the first lever and the second lever as the collar clip is coupled to a pet's collar.

16. A pet restraint system comprising:
a collar clip;
a pet lead;
a headrest anchor;
a fulcrum;
a swivel connector;
the collar clip comprising a first lever, a second lever, a clip body, and at least one tensioner;
the pet lead comprising a lead cable, a first lead loop, and a second lead loop;
the headrest anchor comprising an anchor cable, a first anchor loop, and a second anchor loop;
the first lever comprising a first clasp;
the second lever comprising a second clasp;
the clip body comprising an upper body portion and a lower body portion;
the first lead loop and the second lead loop each comprise a loop shield;
the upper body portion comprising a collar-receiving cavity;
the lower body comprising a cable connector;
the first lever and the second lever being rotatably coupled to the clip body by the fulcrum;
the collar-receiving cavity being centrally positioned on the clip body;
a cavity opening of the collar-receiving cavity being operatively occluded by the first clasp and the second clasp;
the first lead loop and the second lead loop being each formed by an end of the lead cable being looped and secured by a lead loop sleeve;
the first anchor loop and the second anchor loop being each formed by an end of the anchor cable being looped and secured by an anchor loop sleeve;
the collar clip being rotatably coupled to the first lead loop by the cable connector;
the second lead loop being rotatably coupled to the anchor cable by the swivel connector;
the loop shield of the first lead loop being configured to protect the first lead loop from damage;
the loop shield of the second lead loop being configured to protect the second lead loop from damage; and
the at least one tensioner being coupled to the first lever and the second lever.

17. The pet restraint system as claimed in claim 16, wherein the loop shield of the first lead loop and the loop shield of the second lead loop are made of metal, and wherein the loop shield of the first lead loop is configured to reduce friction between engagement surfaces of the cable connector and the first lead loop, and wherein the loop shield of the second lead loop is configured to reduce friction between engagement surfaces of the swivel connector and the second lead loop.

18. The pet restraint system as claimed in claim 16, wherein a width of the upper body portion is configured to shield the first lever and the second lever as the collar clip is coupled to a pet's collar, and wherein the anchor cable is configured to attach to a vehicle seat by threading one headrest post through the first anchor loop and by threading another headrest post through the second anchor loop.

19. The pet restraint system as claimed in claim 16, wherein the anchor cable and the lead cable are two steel cables, and wherein each of the two steel cables is sleeved with a fabric material and is a 7-strand steel cable, and wherein the swivel connector is a steel swivel.

20. The pet restraint system as claimed in claim 16 comprising:
the anchor cable and the lead cable being arranged into a T-shaped configuration; and
the swivel connector being at a nexus of the T-shaped configuration.
